(19) United States
(12) Patent Application Publication
(10) Pub. No.: US 2025/0227062 A1
(43) Pub. Date: Jul. 10, 2025

(54) DATA TRANSFER DEVICE AND DATA TRANSFER METHOD

(71) Applicant: Nippon Telegraph and Telephone Corporation, Tokyo (JP)

(72) Inventors: Naoki Miura, Tokyo (JP); Takeshi Sakamoto, Tokyo (JP); Yuki Arikawa, Tokyo (JP); Tsuyoshi Ito, Tokyo (JP); Kenji Tanaka, Tokyo (JP); Masaru Katayama, Tokyo (JP); Yuta Ukon, Tokyo (JP)

(21) Appl. No.: 18/705,352

(22) PCT Filed: Nov. 8, 2022
(86) PCT No.: PCT/JP2022/041555

§ 371 Date: Apr. 26, 2024

(30) Foreign Application Priority Data
Nov. 12, 2021 (JP) 2021-184730

(51) Int. Cl. H04L 45/50; H04L 47/34

(52) U.S. Cl. CPC H04L 45/50; H04L 47/34

(57) ABSTRACT

A data transfer device has, under control, a data processing device that performs data processing of a service function for data included in a received packet, receives a packet including a tag including a service function number of a service function constituting a service chain for implementing a service requested by a user and identification information of the service chain, acquires a transfer destination candidate of the packet from a routing table using the service function number of the received packet, decides a transfer destination of the packet based on the identification information of the service chain, and transfers the received packet to the data processing device or the data transfer device.

### CROSS-REFERENCE TO RELATED APPLICATIONS

This application is a national phase entry of PCT Application No. PCT/JP2022/041555, filed on Nov. 8, 2022, which claims priority to Japanese Patent Application No. 2021-184730, filed on Nov. 12, 2021, which applications are hereby incorporated herein by reference.

### TECHNICAL FIELD

The present invention relates to a data transfer device that provides a service to a user by a service function chaining technique, and a data transfer method.

### BACKGROUND

To flexibly provide an end-to-end service, Service Function Chaining (SFC) has been examined (non-patent literature 1). SFC is a technique of freely combining Service Functions (SF) scattered on a network, and it is possible to provide an optimum service for each user by using the SFC.

The SFC has been examined to implement a flexible network service, and this is a technique advantageous for a cloud service as well. For example, non-patent literature 2 discloses, as an image processing service using the SFC, a video monitoring service that combines two types of image processing functions.

In a network using the SFC, as shown in FIG. 8, a classifier 10 at the inlet adds a tag to a packet 11 on a user basis, and a Service Function Forwarder (SFF) 12 transfers the packet 11 to an appropriate SF based on the tag. In FIG. 8, reference numeral 13 denotes a server that implements an SF; and 14, a service chain in which SFs provided to a user are connected in a row. Using the SFC, a user can construct a unique service by combining SFs suitable for his/her purpose.

In non-patent literature 3, an SFC using a Network Service Header (NSH) is proposed. In a method using the NSH, a header having a data structure as shown in FIG. 9 is used. The SFF refers to an NSH added to a packet, and control the transfer destination of the packet based on a service chain identifier (Service Path Identifier (SPI)) and a current location (Service Index (SI)) in the service chain. If the SI is updated every time data processing is performed in the SF, the packet can move between SFs in the service chain.

### RELATED ART LITERATURE

### Non-Patent Literature

Non-Patent Literature 1: RFC 7665-Service Function Chaining (SFC) Architecture, Internet Engineering Task Force (IETF), October 2015, <https://datatracker.ietf.org/doc/html/rfc7665>
Non-Patent Literature 2: Yuta UKON, Koji YAMAZAKI, Koyo NITTA, “Real-Time Image Processing Based on Service Function Chaining Using CPU-FPGA Architecture”, IEICE Transactions on Communications, Vol. E103-B, No. 1, pp. 11-19, 2020, <https://search.ieice.org/bin/summary.php?id=e103-b_1_11>
Non-Patent Literature 3: RFC 8300-Network Service Header (NSH) Internet Engineering Task Force (IETF), January 2018, <https://datatracker.ietf.org/doc/html/rfc8300)>

### SUMMARY

### Problem to be Solved by Embodiments of the Invention

In a computer network, communication using the TCP/IP protocol is the mainstream. The TCP/IP protocol is used for communication between computers, and a service chain is not taken into consideration. If the SFC is implemented using the TCP/IP protocol, after data processing is performed in an SF, the sending destination needs to be rewritten to the next SF. The SF consumes extra calculation resources for this processing, and there is an adverse effect on service performance because a processing delay in the SF increases.

On the other hand, in an SFC using the NSH, information about a service chain is added to a packet, and rewrite of sending information in an SF is unnecessary. FIGS. 10A and 10B show examples of configurations of an SFC using the NSH and a routing table. In the routing table shown in FIG. 10B, a current location (SI) in a service chain and the transfer destination (a next hop that is the latest transfer destination and an output port) of data are registered in correspondence with each service chain identifier (SPI). In the routing table shown in FIG. 10B, routing information needs to be held for each service chain. Hence, if the routing table is exhausted, routing of a new service chain is impossible.

Embodiments of the present invention have been made to solve the above-described problem, and has as its object to provide a data transfer device capable of routing a new service chain even if a routing table is exhausted.

### Means of Solution to the Problem

A data transfer device according to embodiments of the present invention having, under control, at least one data processing device configured to perform data processing of a service function for data included in a received packet, the data transfer device comprises a packet reception unit configured to receive a packet including a tag, the tag including a service function number unique to the service function constituting a service chain for implementing a service requested by a user and identification information of the service chain; and a transfer control unit configured to transfer the received packet to the data processing device under control or another data transfer device based on a routing table registered in the data transfer device on a route of the service chain, wherein the transfer control unit acquires a transfer destination candidate of the packet from the routing table using the service function number included in the tag of the received packet, and decides a transfer destination of the packet based on the identification information of the service chain.

A data transfer method according to embodiments of the present invention is a data transfer method in a data transfer device that has, under control, at least one data processing device configured to perform data processing of a service function for data included in a received packet and transfers the received packet to the data processing device under control or another data transfer device based on a registered routing table, comprising a step of receiving a packet including a tag including a service function number unique to the service function constituting a service chain and identification information of the service chain, a step of acquiring the identification information of the service chain and the service function number from the tag of the received packet, a step of searching the routing table using the service function number and acquiring a transfer destination candidate of the packet, a step of comparing identification information of the transfer destination candidate and that of the service chain, and if there exists a transfer destination candidate whose identification information matches that of the service chain, acquiring transfer destination information from the transfer destination candidate, and a step of outputting the packet based on the acquired transfer destination information.

### Effect of Embodiments of the Invention

Since the data transfer device and the data transfer method according to embodiments of the present invention are configured to acquire transfer destination candidates of a packet using a service function number added to the received packet and decide the transfer destination of the packet based on the identification information of a service chain, service chains using the same service function can be managed together. For this reason, even if the routing table is exhausted, it is possible to perform routing of a new service chain using a known service function.

### BRIEF DESCRIPTION OF THE DRAWINGS

FIG. 1 is a block diagram showing an example of the configuration of a data processing system using a data transfer device according to the embodiment of the present invention;

FIG. 2A is a view for explaining the operation of the data transfer device according to the embodiment of the present invention;

FIG. 2B is a view showing an example of the configuration of a routing table in the data transfer device according to the embodiment of the present invention;

FIG. 3 is a block diagram showing an example of the configuration of the data transfer device and data processing devices according to the embodiment of the present invention;

FIG. 4 is a flowchart for explaining the operation of the data transfer device according to the embodiment of the present invention;

FIG. 5 is a flowchart for explaining the operation of the data processing device under control of the data transfer device according to the embodiment of the present invention;

FIG. 6 is a view for explaining the data structure of a packet in the data transfer device according to the embodiment of the present invention;

FIG. 7 is a block diagram showing an example of the configuration of a computer that implements the data processing device according to the embodiment of the present invention;

FIG. 8 is a view for explaining an example of the configuration of conventional service function chaining;

FIG. 9 is a view for explaining the data structure of a packet in the conventional service function chaining;

FIG. 10A is a view for explaining the operation of the conventional service function chaining; and

FIG. 10B is a view showing an example of the configuration of a routing table in the conventional service function chaining.

### DETAILED DESCRIPTION OF ILLUSTRATIVE EMBODIMENTS

The embodiment of the present invention will now be described with reference to the accompanying drawings. The present invention can be implemented in a lot of different modes, and should not be interpreted only concerning the embodiment of the present invention to be described below.

### <Data Processing System Using Data Transfer Device>

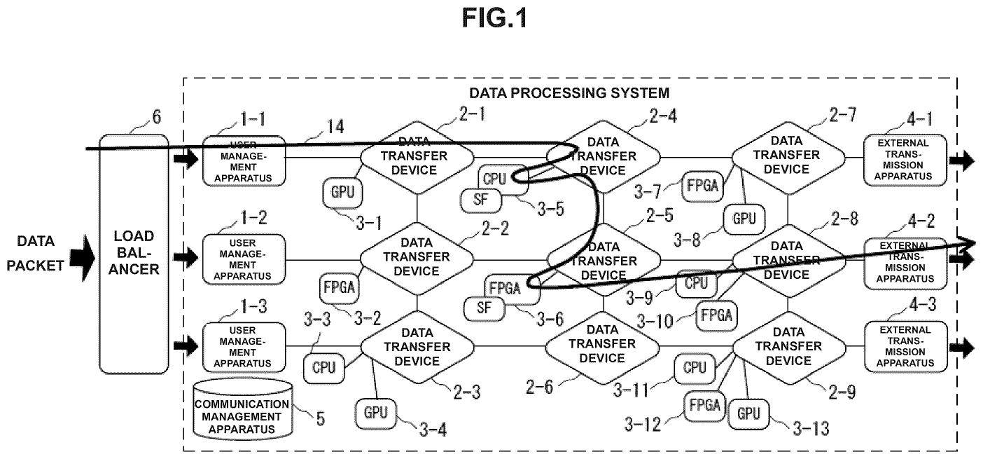

FIG. 1 is a block diagram showing an example of the configuration of a data processing system using a data transfer device according to the embodiment of the present invention. The data processing system includes user management apparatuses 1-1 to 1-3 each of which manages the information of a user who has applied use of a service and controls transfer of a packet received from the user, one or a plurality of data transfer devices 2-1 to 2-9 each of which transfers packets, data processing devices 3-1 to 3-13 each of which performs data processing in an SF for data included in a received packet, and external transmission apparatuses 4-1 to 4-3 each of which returns a packet that has undergone all data processes of a service chain to a user.

The data processing system also includes a communication management apparatus 5 that calculates the route of a service chain necessary for implementing a service requested by each user, transmits route information to the user management apparatuses 1-1 to 1-3, and updates, based on the result of route calculation, routing tables registered in the data transfer devices 2-1 to 2-9 on the calculated route.

As the data processing devices 3-1 to 3-13, a Central Processing Unit (CPU), a Field-Programmable Gate Array (FPGA), a Graphics Processing Units (GPU), an Application Specific Integrated Circuit (ASIC), and the like are included.

In this embodiment, SFs implemented by the data processing devices 3-1 to 3-13 are combined, thereby providing a service customized for each user. More specifically, communication is performed between the data transfer devices 2-1 to 2-9, and a data packet sent from a user is transferred to an appropriate SF. If data processing in the SF is completed, the data packet is further transferred to another SF, and data processing is performed. Thus, in this embodiment, a combination of services for implementing a service requested by the user is provided by changing the processing contents for each user.

A communication path through which a data packet passes is called a service chain. Reference numeral 14 in FIG. 1 indicates an example of a service chain. If a plurality of users simultaneously use the service chain, data collide in the SFs, and an appropriate result cannot be guaranteed. Hence, in the data processing system according to this embodiment, data packets are managed in the user management apparatuses 1-1 to 1-3 at the inlet, thereby controlling such that only one user can use the service chain.

The user management apparatuses 1-1 to 1-3 each also perform tag addition to a data packet. In the tag, route information (destination information) formed by a combination of SFs of a service chain is described. The data transfer devices 2-1 to 2-9 perform routing of a data packet by referring to the added tag, and transfer the packet to an SF of a target data processing device.

The external transmission apparatuses 4-1 to 4-3 each packetize data that has undergone data processing into an IP packet and return it to the user. As communication outside the data processing system, TCP/IP is used as the world standard. On the other hand, in the data processing system that performs routing of a service chain, packet communication using a tag is performed. To absorb the difference of the protocols in and outside the data processing system, the external transmission apparatuses 4-1 to 4-3 are used.

### <Transfer Control in Data Transfer Device>

The data transfer device according to this embodiment refers to the service function number (SF number) of a service function constituting a service chain and the identification information (UID) of the service chain, which are added to the transfer data of a packet, thereby controlling the transfer destination of data. The SF number is a unique value assigned to each SF, and the UID is a value for identifying a service chain of a user.

More specifically, candidates of a transfer destination (a next hop that is the latest transfer destination and an output port) of data are acquired using an SF number, and the transfer destinations are narrowed down using a UID, thereby deciding the transfer destination of a packet. Here, a transfer destination may be defined by putting a plurality of UIDs together. As for how to put UIDs together, UIDs may be put together based on common portions, or a default transfer destination may be defined for a plurality of UIDs. However, the present invention is not limited to these.

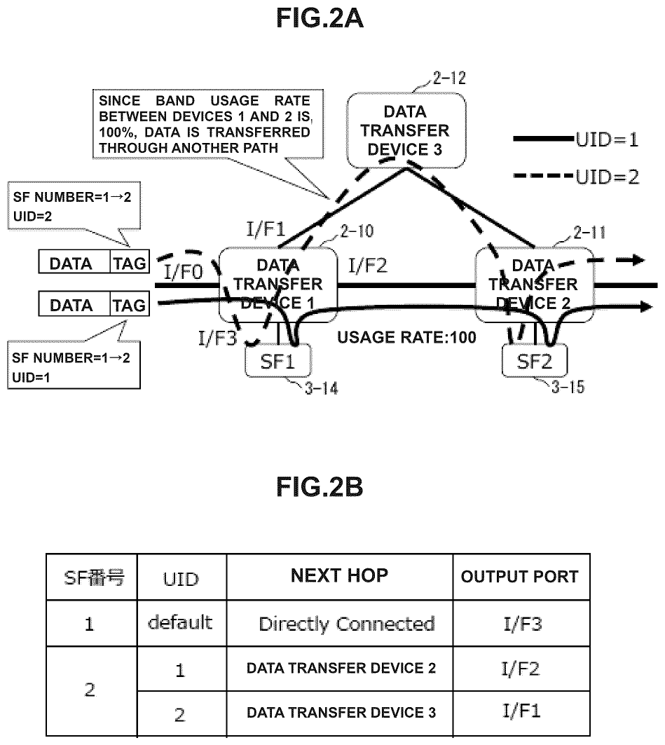

FIG. 2A is a view for explaining the operation of the data transfer device according to the embodiment of the present invention. In FIG. 2A, two users use services in which SF₁ and SF₂ are combined, and as the identification information of a service chain, UID=1 is added to the data of one user, and UID=2 is added to the data of the other user. Since the service chains of both users include SF₁ and SF₂, SF number 1 and SF number 2 are described in the route information (destination information) of the tag of the packet.

In the example shown in FIG. 2A, since the band between data transfer device 1 and data transfer device 2 is tight, the communication path is changed for each service chain (UID). Even if a service chain using the same service function exists, the transfer destination can be changed for each service chain using the UID.

FIG. 2B is a view showing an example of the configuration of a routing table in the data transfer device according to the embodiment of the present invention. In the configuration example shown in FIG. 2B, a UID that is the identification information of a service chain and, as transfer destination information, a next hop that is the latest transfer destination and the number of a port for outputting a packet are registered in association with each other for each SF number of a service function. In the routing table according to this embodiment, the service chains (UID₁ and UID₂) using the same SFs (SF₁ and SF₂) are managed together.

In a case where a packet whose SF number at the top is [1] is received, since only the default transfer destination is registered in the routing table, the data transfer device 1 (2-10) transmits the data from output port I/F₃ to SF₁ independently of the UID. On the other hand, in a case where a packet whose SF number at the top is [2] is received, the data transfer device selects an output port corresponding to one transfer destination from two transfer destination candidates in accordance with the UID and transmits the packet from I/F₁ to I/F₂.

If data processing is performed in SF₁, the SF number is updated in SF₁ after the data processing, and the SF number of SF₁ that has performed the data processing is deleted. The SF number at the top of the route information (destination information) added to the packet is thus changed, the data transfer device 1 (2-10) that has received the packet after the data processing can send the received packet to the next SF.

As described above, the data transfer device according to this embodiment is configured to acquire transfer destination candidates of a packet using the SF number added to the received packet and decide the transfer destination of the packet based on the identification information of the service chain. Hence, service chains using the same SFs can be managed together. For this reason, even if the routing table is exhausted, it is possible to perform routing of a new service chain using a known service function. However, a condition is that the number of transfer destination candidates is not increased by the new service chain.

### <Configuration of Data Transfer Device and Data Processing Device>

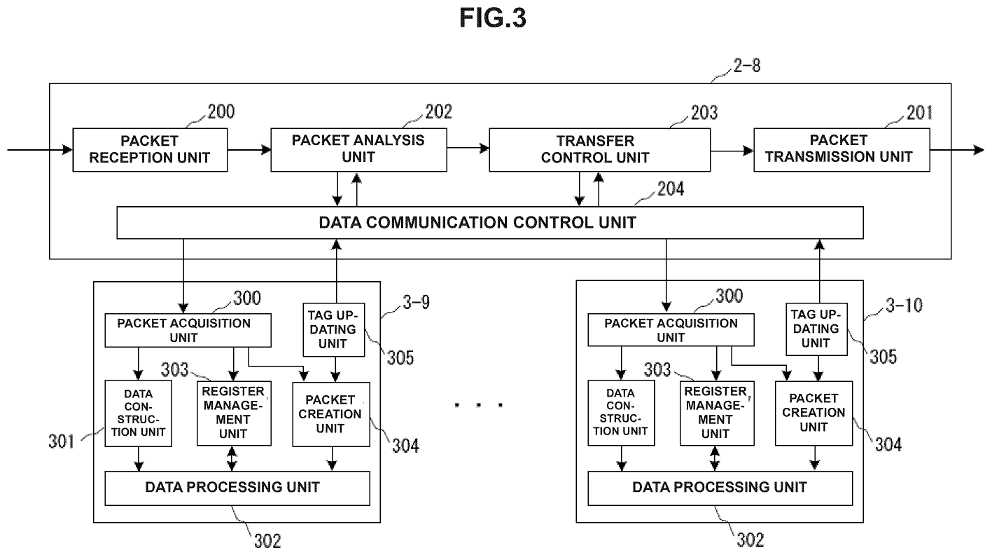

FIG. 3 is a block diagram showing the configuration of the data transfer device 2-8 and the data processing devices 3-9 and 3-10. In the configuration example shown in FIG. 3, the data transfer device 2-8 has, under control, the data processing devices 3-9 and 3-10 configured to perform data processing of a service function for data included in a received packet.

The data transfer device 2-8 is formed by a reception unit 200, a packet transmission unit 201, a packet analysis unit 202, a transfer control unit 203, and a data communication control unit 204.

The packet reception unit 200 receives a packet from a user management apparatus or a data transfer device. A tag including a service function number unique to a service function constituting a service chain and the identification information of the service chain is added to the received packet.

The transfer control unit 203 is configured to transfer the received packet to a data processing device under control or another data transfer device based on a routing table registered in advance. The routing table is registered in advance in each data transfer device on the route of a service chain. The transfer control unit 203 acquires transfer destination candidates of the packet using the service function number added to the received packet, and decides the transfer destination of the packet from the transfer destination candidates based on the identification information of the service chain.

Each of the data processing devices 3-9 and 3-10 connected under control of the data transfer device 2-8 is formed by a packet acquisition unit 300, a data construction unit 301, a data processing unit 302, a register management unit 303, a packet creation unit 304, and a tag updating unit 305.

### <Operations of Data Transfer Device and Data Processing Device>

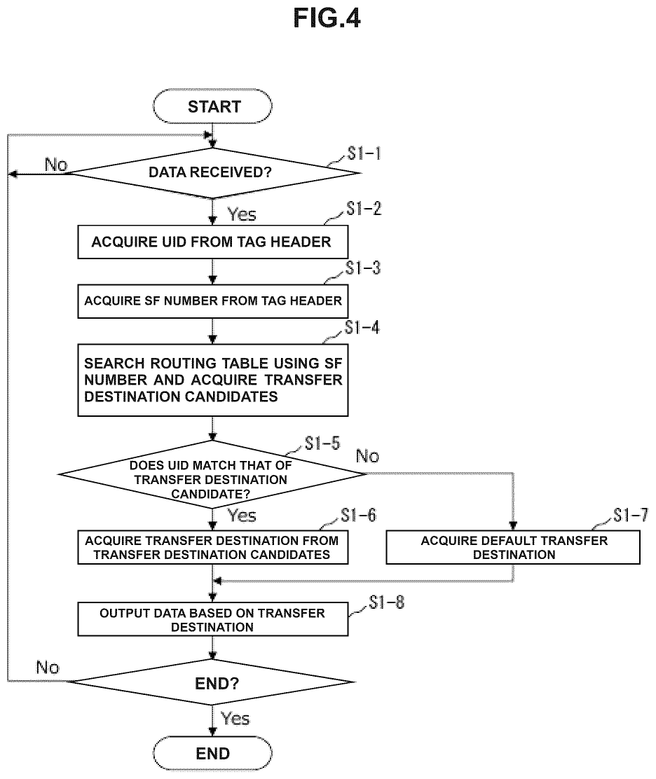

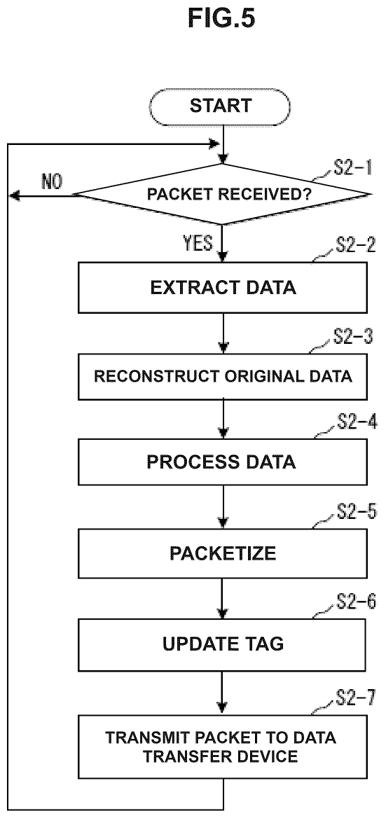

FIG. 4 is a flowchart for explaining the operation of the data transfer method of the data transfer device according to the embodiment of the present invention. FIG. 5 is a flowchart for explaining the operation of the data processing device under control of the data transfer device according to the embodiment of the present invention.

In the flowchart shown in FIG. 4, if the packet reception unit 200 of the data transfer device 2-8 receives a packet (step S1-1), the packet analysis unit 202 analyzes the received packet and acquires a UID and an SF number from a tag header added to the packet (steps S1-2 and S1-3). As for the SF number, the SF number at the top is acquired from at least one SF number added to the data, and the acquired UID and SF number are transmitted to the transfer control unit 203 together with the received packet.

The transfer control unit 203 searches the routing table using the acquired SF number, and acquires transfer destination candidates of data (step S1-4). The acquired transfer destination candidates and the UID of the received packet are compared (step S1-5). If the UID matches the UID of a transfer destination candidate, a transfer destination (a next hop that is the latest transfer destination and an output port) is acquired from the transfer destination candidates. If no UID in the routing table matches, a default transfer destination corresponding to the SF number is acquired (step S1-6).

For example, in the configuration example shown in FIG. 3, it is decided whether to transfer the packet output from the packet analysis unit 202 to the data processing device 3-9 or 3-10 via the data communication control unit 204 or transfer the packet to an adjacent data transfer device via the packet transmission unit 201.

In the flowchart shown in FIG. 5, if the packet output from the packet analysis unit 202 is transferred to the data processing device 3-9 or 3-10 via the data communication control unit 204, the packet acquisition unit 300 of the data processing device 3-9 or 3-10 receives the packet from the data transfer device 2-8 (step S2-1), and extracts a payload portion (processing target data and the like) from the received packet (step S2-2). Here, the information of the tag which have been added to the received data packet is transmitted to the packet creation unit 304 to packetize the data after processing.

The data construction unit 301 of the data processing device 3-9 or 3-10 combines the payloads of a plurality of data packets acquired by the packet acquisition unit 300, thereby reconstructing original data (step S2-3).

Since the order of the plurality of packets which have arrived and construct the original data may have been changed, the data construction unit 301 performs packet order control and arranges the processing target data extracted from the plurality of packets in a correct order. The packet order control can be performed based on a sequence number included in the tag of each packet. The data construction unit 301 transmits the data that is reconstructed and is processible to the data processing unit 302.

The data processing unit 302 executes data processing of a predetermined service function for the data received from the data construction unit 301, and transmits the data that has undergone the data processing to the packet creation unit 304 (step S2-4).

The packet creation unit 304 packetizes the data received from the data processing unit 302 using the information of the tag added to the received data packet, and transmits the generated packet to the tag updating unit 305 (step S2-5).

The tag updating unit 305 refers to route information (destination information) of the SF number included in the tag added to the packet received from the packet creation unit 304, updates the route information included in the tag to exclude the SF (in the data processing device 3-9 or 3-10) that has executed the data processing from the route of the service chain (step S2-6), and transmits the packet with the updated route information to the data transfer device 2-8 (step S2-7).

Although not explicitly shown in the flowchart of FIG. 5, the register management unit 303 of the data processing device 3-9 or 3-10 performs acquisition of a parameter from tag data and registration in the data processing device. More specifically, the register management unit 303 acquires a user-specific parameter necessary for processing of the SF from the user management apparatus via the tag of the received packet, and registers the acquired parameter in the data processing unit 302. The parameter can be used when, for example, changing processing in the data processing unit for each user (each UID).

Using a parameter corresponding to the UID acquired by the packet acquisition unit 300 among parameters registered by the register management unit 303, the data processing unit 302 executes data processing of a predetermined service function for the data received from the data construction unit 301.

If the packet that has undergone data processing is received from the data processing device 3-9 or 3-10, the data transfer device 2-8 performs packet transfer control based on the routing table as in the above-described case where a packet is received from the user management apparatus or the data transfer device.

Upon receiving the packet that has undergone data processing from the data processing device 3-9 or 3-10 via the data communication control unit 204 (step S1-1), the packet analysis unit 202 analyzes the packet received from the data processing device 3-9 or 3-10, acquires the UID and the SF number from the tag added to the packet, and outputs the acquired UID and SF number and the received packet to the transfer control unit 203 (steps S1-2 and S1-3).

As in the above-described case where the packet is received from the packet reception unit 200, the transfer control unit 203 searches the routing table using the SF number, and acquires transfer destination candidates of the data. The transfer destination candidates and the UID of the received data are compared, and if the UIDs match, a transfer destination (a next hop that is the latest transfer destination and an output port) is acquired from the transfer destination candidates. Otherwise, a default transfer destination corresponding to the SF number is acquired.

In the configuration example shown in FIG. 3, as in the above-described case where the packet is received from the packet reception unit 200, it is decided whether to transfer the packet output from the packet analysis unit 202 to the data processing device 3-9 or 3-10 via the data communication control unit 204 or transfer the packet to an adjacent data transfer device via the packet transmission unit 201. Here, since the SF number of the data processing device 3-9 or 3-10 that has processed data is excluded from the route information of the service chain by updating the tag by the tag updating unit 305, as described above, the data processing device (SF) that has completed the processing is never selected as the transfer destination.

If the plurality of data processing devices 3-9 and 3-10 are connected in parallel to the data transfer device 2-8, as in the configuration example shown in FIG. 3, each of the data processing devices 3-9 and 3-10 can be accessed with little overhead. Also, if the data processing devices 3-9 and 3-10 are independent of the data transfer device 2-8, a new data processing device can be added or deleted without impeding communication between the existing data processing devices 3-9 and 3-10 and the data transfer device 2-8.

Note that in the example shown in FIGS. 3, 4, and 5, a description has been made using the data transfer device 2-8 and the data processing devices 3-9 and 3-10 as an example. The configuration and operation of the data transfer devices 2-1 to 2-7 and 2-9 shown in FIG. 1 are the same as the data transfer device 2-8, and the configuration and operation of the data processing devices 3-1 to 3-8 and 3-11 to 3-13 are the same as the data processing devices 3-9 and 3-10.

### <Data Structure>

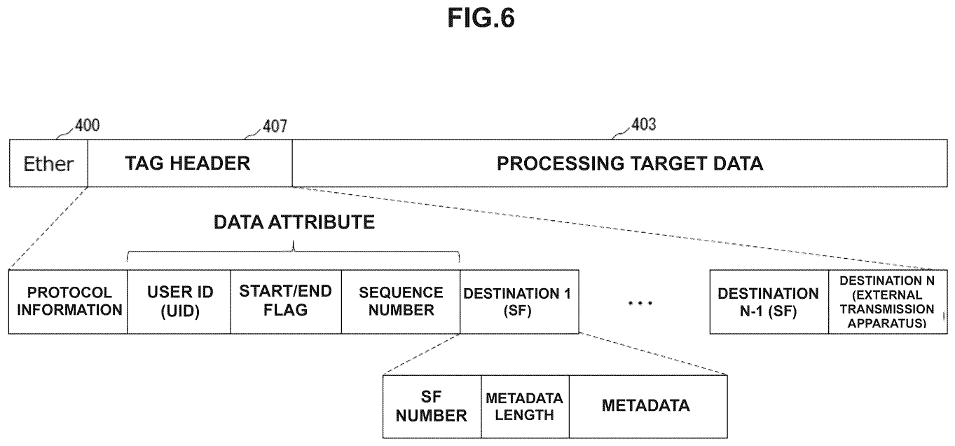

FIG. 6 is a view showing an example of the configuration of a data structure in the data transfer device according to the embodiment of the present invention. Transfer data transferred in the service function chaining system according to the embodiment of the present invention can be formed by a tag header 407 including protocol information, a data attribute, and destination information (route information), and processing target data 403 that is the target of data processing.

In the protocol information of the tag header 407, information concerning data discard such as Time to Live (TTL) and header checksum and information concerning the configuration of the tag header such as a data type and a header length can be set.

In the data attribute of the tag header 407, a UID for identifying a service chain can be set. Since a user who uses a cloud service sometimes divides processing target data into a plurality of packets and sends these, a start/end flag used by an SF to recognize a break of processing target data, and a sequence number used to rearrange processing target data in a correct order if the order of the processing target data is changed can be set.

As the route information of the service chain, at least one piece of destination information (SF) is included. In the destination information, service function numbers (SF numbers) of destinations that form the service chain are arranged in the order of data processing in the service chain. In the destination information, metadata to the SF can be set in addition to the SF number. When a metadata length is set in the destination information, metadata having an arbitrary length can be set.

As one of utilization methods of metadata, registration or updating of the parameter of the data processing device (SF) by the register management unit 303 described with reference to FIG. 3 is performed. If a plurality of service chains share an SF, the parameter of the SF sometimes needs to be changed in accordance with the service chain. At this time, when a parameter is set in the metadata of destination information, the parameter can be registered in each SF in accordance with the service chain. The SF can discriminate, by the data type in the protocol information of the tag header, whether the data is processing target data or a parameter.

Like the configuration example shown in FIG. 6, the above-described data may be encapsulated by an Ethernet frame. If communication is performed via an L2 switch using the Ethernet frame, connections beyond the number of output ports of the data transfer device can be implemented by connecting a plurality of SFs to one port of the data transfer device.

Each of the data transfer devices 2-1 to 2-9 and the data processing devices 3-1 to 3-13 described in this embodiment can be implemented by a computer including a CPU (or a GPU), a storage device, and an interface, and a program that controls these hardware resources.

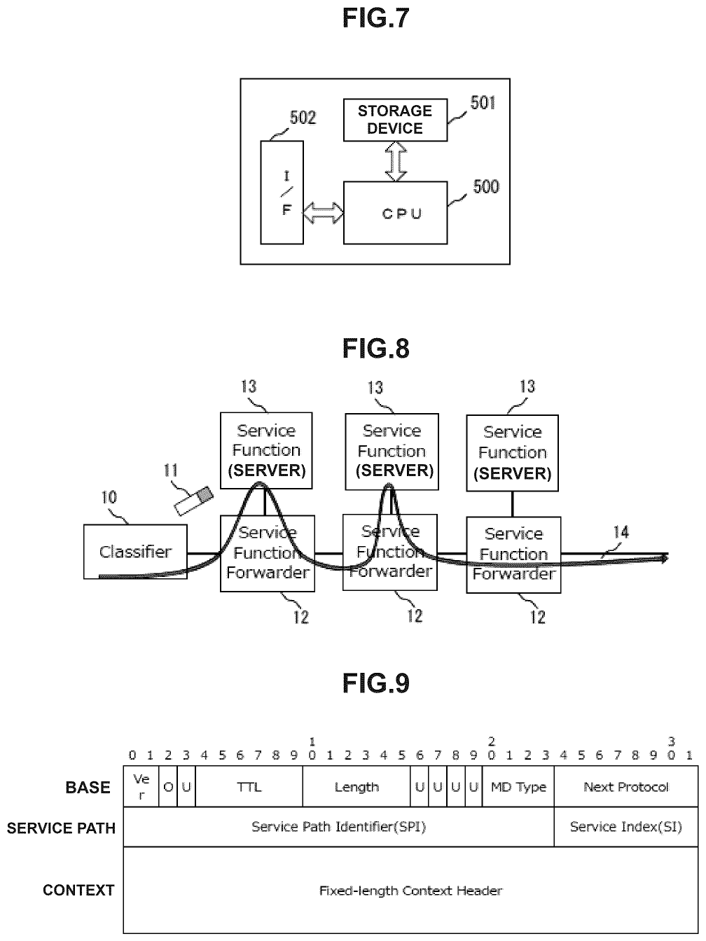

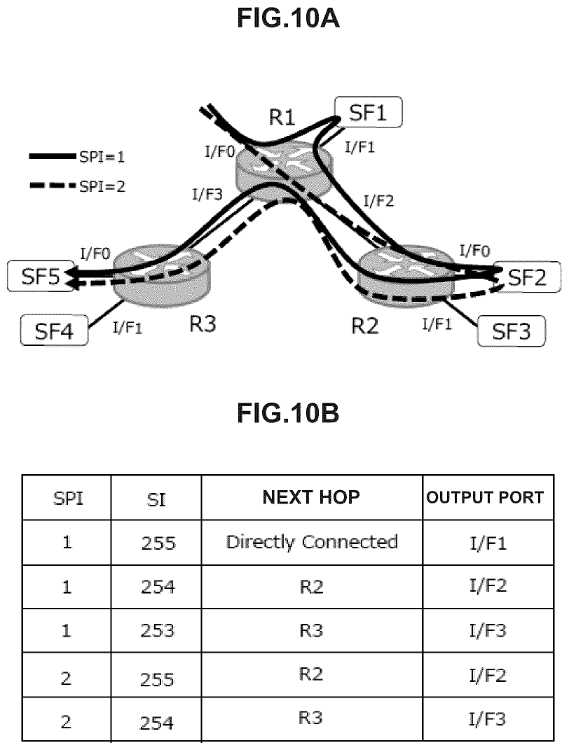

FIG. 7 shows an example of the configuration of the computer. The computer includes a CPU 500 (or a GPU), a storage device 501, and an interface device 502. In such a computer, a program configured to implement a data processing method according to embodiments of the present invention is stored in the storage device 501. The CPU 500 (or the GPU) of each apparatus executes processing described in this embodiment in accordance with the program stored in the storage device 501.

At least some of the data transfer devices 2-1 to 2-9, the data processing devices 3-1 to 3-13, the user management apparatuses 1-1 to 1-3, and the external transmission apparatuses 4-1 to 4-3 may be formed by an FPGA or an ASIC. In particular, if part of packet processing and data processing is executed by these pieces of hardware, processing performance can be expected to be improved.

As described above, since the data transfer device according to this embodiment is configured to acquire transfer destination candidates of a packet using a service function number added to the received packet and decide the transfer destination of the packet based on the identification information of a service chain, service chains using the same SFs can be managed together. For this reason, even if the routing table is exhausted, it is possible to perform routing of a new service chain using a known service function.

Some or all of the above-described embodiments can also be described as in the following supplementary notes but are not limited to the followings.

(Supplementary Note 1) According to embodiments of the present invention, there is provided a data transfer device having, under control, at least one data processing device configured to perform data processing of a service function for data included in a received packet, comprising a packet reception unit configured to receive a packet including a tag, the tag including a service function number unique to the service function constituting a service chain for implementing a service requested by a user and identification information of the service chain, and a transfer control unit configured to transfer the received packet to the data processing device under control or another data transfer device based on a routing table registered in the data transfer device on a route of the service chain, wherein the transfer control unit acquires a transfer destination candidate of the packet from the routing table using the service function number included in the tag of the received packet, and decides a transfer destination of the packet based on the identification information of the service chain.

(Supplementary Note 2) In the data transfer device according to Supplementary Note 1, the transfer control unit decides the transfer destination of the packet using information of the updated service function number of the packet that has undergone data processing in the data processing device when the received packet is transferred to the data processing device under control.

(Supplementary Note 3) In the data transfer device according to Supplementary Note 1 or 2, in the routing table, the identification information of the service chain and transfer destination information of the packet are registered in association with each other for each service function number unique to the service function.

(Supplementary Note 4) In the data transfer device according to any one of Supplementary Notes 1 to 3, the packet includes processing target data that is a target of the data processing, route information of the service chain including at least one service function number, and the tag including the identification information of the service chain, the tag includes a flag used by the service function to recognize a break of the processing target data, and a sequence number used to rearrange the processing target data in a correct order if an order of the processing target data is changed, and in the route information, the service function number is arranged in the order of the data processing in the service chain.

(Supplementary Note 5) According to embodiments of the present invention, there is provided a data transfer method in a data transfer device that has, under control, at least one data processing device configured to perform data processing of a service function for data included in a received packet and transfers the received packet to the data processing device under control or another data transfer device based on a registered routing table, comprising a step of receiving a packet including a tag including a service function number unique to the service function constituting a service chain and identification information of the service chain, a step of acquiring the identification information of the service chain and the service function number from the tag of the received packet, a step of searching the routing table using the service function number and acquiring a transfer destination candidate of the packet, a step of comparing identification information of the transfer destination candidate and that of the service chain, and if there exists a transfer destination candidate whose identification information matches that of the service chain, acquiring transfer destination information from the transfer destination candidate, and a step of outputting the packet based on the acquired transfer destination information.

(Supplementary Note 6) In the data transfer method according to Supplementary Note 5, in the step of acquiring the transfer destination information, the transfer destination of the packet is decided using information of the updated service function number of the packet that has undergone data processing in the data processing device when the received packet is transferred to the data processing device under control.

(Supplementary Note 7) In the data transfer method according to Supplementary Note 5 or 6, in the routing table, the identification information of the service chain and transfer destination information of the packet are registered in association with each other for each service function number unique to the service function.

(Supplementary Note 8) In the data transfer method according to any one of Supplementary Notes 5 to 7, the packet includes processing target data that is a target of the data processing, route information of the service chain including at least one service function number, and the tag including the identification information of the service chain, the tag includes a flag used by the service function to recognize a break of the processing target data, and a sequence number used to rearrange the processing target data in a correct order if an order of the processing target data is changed, and in the route information, the service function number is arranged in the order of the data processing in the service chain.

### INDUSTRIAL APPLICABILITY

Embodiments of the present invention can be applied to a service function chaining technique.

### EXPLANATION OF THE REFERENCE NUMERALS AND SIGNS

1-1-1-3 . . . user management apparatus, 2-1-2-12 . . . data transfer device, 3-1-3-15 . . . data processing device, 4-1-4-3 . . . external transmission apparatus, 5 . . . communication management apparatus, 6 . . . load balancer, 200 . . . packet reception unit, 201 . . . packet transmission unit, 202 . . . packet analysis unit, 203 . . . transfer control unit, 204 . . . data communication control unit, 300 . . . packet acquisition unit, 301 . . . data construction unit, 302 . . . data processing unit, 303 . . . register management unit, 304 . . . packet creation unit, 305 . . . tag updating unit.

1-8. (canceled)

9. A data transfer device, the data transfer device comprising:
a storage device comprising instructions; and
one or more processors in communication with the storage device, wherein the one or more processors execute the instructions to:
receive a packet including a tag, the tag including a service function number unique to a service function and identification information of a service chain; and
transfer the packet to a data processing device controlled by the data transfer device or to another data transfer device based on a routing table registered in the data transfer device on a route of the service chain, wherein a transfer destination candidate of the packet is acquired from the routing table based on the service function number included in the tag of the packet, and a transfer destination of the packet is determined based on the identification information of the service chain.

10. The data transfer device according to claim 9, wherein the instructions include further instructions to:
after the packet is transferred to the data processing device, decide a transfer destination of a processed packet based on information of an updated service function number of the processed packet, wherein the processed packet has undergone data processing in the data processing device.

11. The data transfer device according to claim 9, wherein:
the packet further includes processing target data that is a target of data processing for the packet, and route information of the service chain including at least one service function number;
the tag further includes a flag used by the service function to recognize a break of the processing target data, and a sequence number used to rearrange the processing target data in a correct order when an order of the processing target data is changed; and
the route information includes the service function number arranged in the order of the data processing in the service chain.

12. The data transfer device according to claim 10, wherein in the routing table,
the identification information of the service chain and transfer destination information of the packet are registered in association with each other for each service function number unique to the service function.

13. The data transfer device according to claim 9, wherein in the routing table,
the identification information of the service chain and transfer destination information of the packet are registered in association with each other for each service function number unique to the service function.

14. The data transfer device according to claim 13, wherein:
the packet further includes processing target data that is a target of data processing for the packet, and route information of the service chain including at least one service function number;
the tag further includes a flag used by the service function to recognize a break of the processing target data, and a sequence number used to rearrange the processing target data in a correct order when an order of the processing target data is changed; and
the route information includes the service function number arranged in the order of the data processing in the service chain.

15. The data transfer device according to claim 9, wherein
the packet further includes processing target data that is a target of data processing for the packet, and route information of the service chain including at least one service function number;
the tag further includes a flag used by the service function to recognize a break of the processing target data, and a sequence number used to rearrange the processing target data in a correct order when an order of the processing target data is changed; and
the route information includes the service function number arranged in the order of the data processing in the service chain.

16. A data transfer method, applied to a data transfer device, the data transfer method comprising:
receiving a packet including a tag including a service function number unique to a service function and identification information of the service chain;
acquiring the identification information of the service chain and the service function number from the tag of the packet;
searching a routing table and acquiring a transfer destination candidate of the packet based on the service function number;
comparing identification information of the transfer destination candidate and identification information of the service chain, and in response to the identification information of the transfer destination candidate matching the identification information of the service chain, acquiring transfer destination information from the transfer destination candidate; and
transfer the packet to a data processing device controlled by the data transfer device or to another data transfer device based on the transfer destination information.

17. The data transfer method according to claim 16, wherein after the packet is transferred to the data processing device, the method further comprises deciding a transfer destination of a processed packet based on information of an updated service function number of the processed packet, wherein the processed packet has undergone data processing in the data processing device.

18. The data transfer method according to claim 17, wherein in the routing table,
the identification information of the service chain and transfer destination information of the packet are registered in association with each other for each service function number unique to the service function.

19. The data transfer method according to claim 17, wherein:
the packet further includes processing target data that is a target of data processing for the packet, and route information of the service chain including at least one service function number;
the tag further includes a flag used by the service function to recognize a break of the processing target data, and a sequence number used to rearrange the processing target data in a correct order when an order of the processing target data is changed; and
the route information includes the service function number arranged in the order of the data processing in the service chain.

20. The data transfer method according to claim 16, wherein in the routing table,
the identification information of the service chain and transfer destination information of the packet are registered in association with each other for each service function number unique to the service function.

21. The data transfer method according to claim 20, wherein:
the packet further includes processing target data that is a target of data processing for the packet, and route information of the service chain including at least one service function number;
the tag further includes a flag used by the service function to recognize a break of the processing target data, and a sequence number used to rearrange the processing target data in a correct order when an order of the processing target data is changed; and
the route information includes the service function number arranged in the order of the data processing in the service chain.

22. The data transfer method according to claim 16, wherein:
the packet further includes processing target data that is a target of data processing for the packet, and route information of the service chain including at least one service function number;
the tag further includes a flag used by the service function to recognize a break of the processing target data, and a sequence number used to rearrange the processing target data in a correct order when an order of the processing target data is changed; and
the route information includes the service function number arranged in the order of the data processing in the service chain.
